(19) United States
(12) Patent Application Publication
(10) Pub. No.: US 2023/0136257 A1
(43) Pub. Date: May 4, 2023

(54) DEVICE AND METHOD THE PRODUCTION AND SECONDARY MACHINING OF LAYERS APPLIED BY LASER CLADDING

(71) Applicant: HPL TECHNOLOGIES GMBH, Aachen (DE)

(72) Inventors: Phillip UTSCH, Wetzlar (DE); Dominik DOBRZANSKI, Alsdorf (DE)

(73) Assignee: HPL TECHNOLOGIES GMBH, Aachen (DE)

(21) Appl. No.: 17/910,282

(22) PCT Filed: Sep. 9, 2020
(86) PCT No.: PCT/DE2020/100787

§ 371 Date: Sep. 8, 2022

(30) Foreign Application Priority Data
Mar. 12, 2020 (DE) 10 2020 106 823.9

(51) Int. Cl. B23K 26/342; B23K 26/00; B23K 26/03; B23K 26/40; B23K 28/02

(52) U.S. Cl. CPC B23K 26/342; B23K 26/0093; B23K 26/03; B23K 26/40; B23K 28/02; B23K 2103/166

(57) ABSTRACT

The invention relates to a device (1) for laser cladding, a method (100) for operating such a device, and a component (4′) produced using such a method and/or such a device comprising a laser cladding unit (2) having at least one laser cladding head (3) disposed thereon, one or more material sources (5) for supplying the laser cladding head with a material (M) to be applied, and a laser beam source (6) for supplying the laser cladding head with laser light (L) for carrying out the laser cladding, wherein the device is configured to apply material layers (42, 43, 44) from an adjacent application cladding track (MS) to a surface (41) of a component (4) in the form of at least a first layer (42) made from a material (M) that comprises structures (42s) projecting from the surface of the first layer and having a first hardness (H1), and a second layer (43) applied thereto made from a material (M) having a second hardness (H2) that is less than the first hardness, and the application process is controlled so that the second layer at least partly covers the structures projecting from the first layer.

### FIELD OF THE INVENTION

The Invention relates to a laser cladding device, a method of operating such a device, and a component manufactured using such a device and/or such a method.

### BACKGROUND OF THE INVENTION

Laser cladding is a process for surface treatment (e.g. coating, repair) and additive manufacturing of components with wire or powder weld materials. Due to the greater robustness against adjustment errors in the process set up and the greater flexibility in the choice of materials, weld materials in powder form are predominantly used. The powder is introduced into a melt pool created by a laser beam on a surface of a component at a defined angle by means of a powder nozzle. During the interaction of laser radiation and powder particles above the melting bath, part of the laser radiation is absorbed by the powder. The non-absorbed part is (multiply) reflected or transmitted. The part of the radiation absorbed by the powder particles leads to a heating of the powder particles, the transmitted part of the radiation creates the melt pool. Depending on the degree of heating of the particles in the beam-substance interaction zone, the particles of the weld material are solid and/or partially or completely liquid before entering the melt pool.

If the component is now moved relative to the laser and the powder feed, the material of the melt pool moves out of the area of influence of the laser radiation and solidifies to form the layer. The prerequisite for the production of defect-free, melt-metallurgically bonded layers is to provide a process heat that is sufficient to initiate a temperature-time cycle that ensures melting of both the substrate and the weld material. Depending on the laser power and the setting of further process parameters (e.g. feed speed, track distance, beam diameter, material feed, etc.), a more or less pronounced mixing of weld material and component material takes place. The powder can be injected laterally or coaxially into the melt pool.

With the usual process control, feed rates, i.e. relative speeds of the component in relation to the laser beam, can typically be reached between 0.2 m/min and 2 m/min. In the process disclosed in DE 10 2011 100 456 84, the supplied material is already melted above the surface by means of an appropriately focused laser beam with high power, so that it already reaches the molten bath on the surface of the component in the molten state, which enables faster processing of the component by further increased feed rates in the range 2≥150 m/min. With the process according to DE 10 2011 100 456 B4, the area rate is now larger (thus the coating duration is smaller) than with conventional process control, but despite the larger area rate DE 10 2011 100 456 84 does not provide any approaches for increasing the cladding rate (cladded amount of powder per time unit).

Depending on the spatial extent of the melt pool, the materials are cladded in wider or less wide cladding tracks with a thickness that varies across the width of the cladding track. The cross-section of such a cladding track perpendicular to the feed direction in which the laser beam moves over the component is usually dome-shaped with a maximum layer thickness in the centre of the cladding track and a thickness decreasing towards zero towards the edges of the cladding track. When material is cladded over an area by laser cladding, the cladding tracks are cladded next to each other and may at least partially overlap. The resulting layer thickness of the material cladded as a layer varies over the individual cladding tracks. In addition, the movement of the molten bath and the adhering, only partially melted powder particles generally result in a high degree of surface roughness (compared to conventional manufacturing processes, e.g. turning, milling, grinding). If a flat layer of cladded material is desired as the end product, the cladded layer must be reworked.

This reworking is time-consuming. Depending on the waviness and roughness of the layer, a lot of cladded material may have to be removed again for smoothing. Especially in the case of hard layers or hard grains in composite layers, conventional smoothing causes a time-consuming reworking step, which may cause considerable mechanical wear on the smoothing agents and thus increase the tooling costs.

Particularly in the case of layer systems containing hard material particles, the cost share of the worn smoothing agents can amount to a considerable part of the value chain. It would therefore be desirable to make the finishing operation simple, reliable and less wear-intensive.

### SUMMARY OF THE INVENTION

It is therefore a task of the invention to provide an effective laser cladding process that enables a simple, reliable and less wear-intensive reworking effort.

This task is solved by a device for laser cladding comprising a laser cladding unit with at least one laser cladding head arranged thereon, one or more material sources for supplying the laser cladding head with a material to be cladded, and a laser beam source for supplying the laser cladding head with laser light for carrying out the laser cladding, the device being configured for the application of layers of material from adjacent cladding tracks to a surface of a component in the form of at least a first layer of a material comprising structures protruding from the surface of the first layer and having a first hardness and a second layer cladded thereon of a material having a second hardness less than the first hardness, the application process being controlled in such a way that the second layer at least partially covers the structures protruding from the first layer.

Terminologically, the following should be explained:

First of all, it should be expressly pointed out that, in the context of the present patent application, indefinite articles and numerical indications such as “one”, “two”, etc. are generally to be understood as “at least” indications, i.e. as “at least one . . . ”, “at least two . . . ”, etc., unless it expressly follows from the respective context or it is obvious or technically imperative for the person skilled in the art that only “exactly one . . . ”, “exactly two . . . ”, etc. can be meant there.

The term “laser cladding” refers to all processes in which a material passing through a laser cladding head in the direction of the component to be processed, for example a material in powder form, is melted in a molten bath generated by the laser beam on the surface of the component by means of a laser beam which is also guided through the material by the laser cladding head in the direction of the component to be processed, and is thus cladded onto the surface of the component which has also been melted by the laser beam. The subsequently solidified material remains there as material welded to the surface in the form of a cladding track. If the cladding tracks are cladded next to each other or even at least partially overlapping, the component can be covered with material in the form of a layer of this material. The laser cladding head comprises, for example, an optical system for the laser beam and a powder feed nozzle including an adjustment unit for the material to be cladded, if necessary with an integrated, local shielding gas supply. The laser beam can also be guided in such a way that the material is already melted in the laser beam, for example by a laser beam that has a focal point above the surface of the component.

The term “laser cladding unit” means an element comprising the laser cladding head or heads. In this context, the laser cladding head or heads may, for example, be mounted on a support plate of the laser cladding unit. Preferably, the attachment may be such that, if there are multiple laser cladding heads, the laser cladding heads can move relative to each other. Furthermore, the laser cladding unit as a whole can be arranged spatially movable in the device, for example on an adjustment unit of the device. As an embodiment, the laser cladding unit may be arranged on a robot arm that can move the laser cladding unit spatially as desired by means of suitable traverse curves. The number of laser cladding heads here is at least one. Two, three, four, five or more laser cladding heads can therefore also be included in the laser cladding unit. How many laser cladding heads can be present in the device is generally a geometrical problem and is determined by the size of the laser cladding heads and the component to be processed.

The term “laser cladding head” means the unit which, by means of the laser beam passing through it, creates a laser cladding point on the surface of the component to be processed and which melts the material in the laser beam, also passing through it, on its way to the surface of the component so that it is welded to the component when it strikes the surface of the component. The term “laser cladding point” refers to the spatial location on the surface of the component where the molten material is cladded onto the surface by laser cladding. The laser cladding point can also be referred to as the melting area of the cladded material, where the material melted by laser light meets the surface of the component.

The cladded material can, for example, be provided in powder form for laser cladding. Here, any material suitable for laser cladding may be used as the material. For example, the material may comprise or consist of metals and/or metal-ceramic composite materials (so-called MMCs). The skilled person may select the materials suitable for the particular laser cladding process. Here, the material may be fed to the laser heads from a single conveyor unit. However, the device may also comprise a plurality of conveyor units, whereby the laser cladding heads may be supplied with different materials, so that the cladding tracks produced by different laser cladding heads may comprise the same or different materials, or the supply of material to one or more laser cladding heads may be changed or switched during laser cladding from one conveyor unit to another conveyor unit with a different material. Material layers are produced from material tracks cladded next to each other in an at least partially overlapping manner. How many material tracks arranged next to each other are needed to provide a surface of the component with a material layer depends, among other things, on the material width of the respective material track. The material width is determined by the details of the design of the laser cladding heads, such as material jet width, laser energy, extension of the laser focus and/or process speed.

The laser radiation is provided by means of one or more laser beam sources. The skilled person can select suitable laser beam sources for laser cladding.

The term “on the surface of the component” refers to the current surface of the component at the time when the respective laser cladding point sweeps over the surface.

The surface of the component need not be the original surface of the component before laser cladding was started. The surface of the component can also be the surface of a cladding track that has already been cladded or of a layer of cladded material, since this is cladded to the previous surface after cladding and thus itself represents the surface of the component for subsequent cladding tracks.

The “protruding structures” are defined here as the texture of the surface that deviates from an ideal flat surface. The texture can be determined numerically in the form of a surface roughness. These structures may be partially within the first layer and protrude from the first layer with only a portion of their structure, the present invention considering only the portion of the structures that actually protrude from the first layer. The part of the structures that is already enveloped by the first layer is not of concern for reworking the cladded layers. Such protruding structures may, for example, be formed during the cladding of composite materials by a second material contained therein. In one embodiment, the first layer comprises a composite material comprising a matrix material having a third hardness lower than the first hardness, preferably the first layer comprises the composite material and the structures are at least partially embedded in the matrix material. Here, the composite material may be a metal-ceramic composite material containing grains forming the structures. For example, such grains are carbide grains. Such materials are characterised in particular by their high abrasion resistance and can be used, for example, as brake coatings. In this case, needles made of a carbide, nitride, oxide or similar material are formed on the surface of such a layer produced by laser cladding. The height of the needle can be up to half of the cladded layer, while the diameter of the needle is significantly smaller than its height.

In one embodiment, the material of the second layer is a metal or metal alloy. Layers of metal can be easily reworked in a defined manner. In a preferred embodiment, the material of the second layer is the matrix material of the first layer. This allows a good material bond to be created between the first and second layers, since the first layer differs from the second layer only in the presence of the structures protruding from the first layer.

By at least partially covering these protruding structures, the surface roughness is reduced compared to components with only one cladded first layer with such structures. In this case, the structures each have a highest point and, in a valley between adjacent structures, the adjacent structures each have a lowest point assigned to them, a distance between the highest and lowest points of the respective structure representing its height, and the second layer covering the structures protruding from the first layer at least up to 20%, preferably at least 40%, more preferably at least 60%, particularly preferably at least 80%, of the average height of all structures. In one embodiment, the second layer completely covers the structures protruding from the first layer. By the fact that the second layer consists of a material whose hardness is lower than that of the protruding structures, reworking of the component is facilitated or, in the case of only a small height of the structures effectively protruding from the second layer as well, unnecessary, since in this case the resulting surface roughness may already meet the requirements for the coated component as the product. With complete coverage of the structures protruding from the first layer, the surface roughness of the coated component corresponds to that of the surface of the second layer. Due to the fact that the second layer has a low hardness, the area of the second layer that protrudes above the structures can easily be removed by means of reworking, so that the structures do not determine the surface roughness of the coated component, but nevertheless have a significant influence on the strength of the overall layer consisting of the first and second layer. Components with a fully covering second layer can be used, for example, as or in drill heads to improve external wear protection. Components with a second layer that does not cover completely can be used, for example, as brake discs, as the friction provided by the structures and the second layer is sufficient. The terms “first layer” and “second layer” are not intended to imply that there cannot be other layers between the “first layer” and the surface of the component. For example, a “third layer” or other layers could be located between the first layer and the component.

The device may further comprise a control unit for controlling the laser cladding process and, if necessary, the rework, which may be any control unit suitable therefor, for example a processor or a computer unit on which an appropriate control program is installed and executed during the laser cladding and/or reworking.

The device according to the invention enables the execution of an effective laser cladding process, which enables a simple, reliable and less wear-intensive reworking effort.

In a further embodiment, the device further comprises a material removal unit which is provided for at least partially removing the structures of the first layer protruding from the second layer when the first layer is not completely covered, or for then partially removing the second layer when the structures of the first layer are completely covered by the second layer.

The term “material removal unit” refers to any form of removal unit with which material of a layer can be removed from this layer without completely detaching the layer from the underlying layers. The material removing process may be mechanical, thermal, chemical or other. In one embodiment, the material removal unit is a grinding unit, a milling unit or a laser melting or laser ablation unit. The material removal unit may be arranged separately from the laser cladding unit or connected to it or integrated in it.

In a further embodiment, the material removal unit is arranged on the laser cladding head downstream of the laser cladding head, as seen in the feed direction of the laser cladding head. This allows the material removing process to be carried out in the same work step as the laser cladding process. If necessary, the residual heat of the laser cladding process can be utilised.

In a further embodiment, the structures of the first layer protruding from the second layer are at least partially removed by being vaporised or melted by the material removal unit. In this case, the material removal unit can be designed as an optical unit that can direct a laser beam onto the surface of the second layer so that the structures of the first layer that still protrude from the second layer are thermally smoothed. For this purpose, it may comprise lenses, mirrors, light guides or other optical components, which may be cooled or subjected to shielding gas. This thermal smoothing is carried out, for example, by melting and subsequent melting to a smoother surface or vaporising the structures. In this case, the material removal unit smoothes the surface in that the smoothing process transforms at least some of the structures in such a way that they disappear as a result of the smoothing process or are at least reduced in size in the direction of a more ideal surface. Thus, the smoothing by the material removal unit reduces the surface roughness of the reworked surface of the second layer. The structures that are thermally preferentially affected by the laser beam are those that have the greatest share in the surface texture or surface roughness of the surface of the second layer to be reworked. During reworking, vaporising can always be carried out particularly effectively and precisely if the structures to be vaporised are narrow and high, so that the thermal conductivity of the structures is significantly lower compared to the layer of the cladded material as an extended body. In this case, the vaporising of the respective structure can take place partially or completely.

This is particularly important, for example, in the case of metal-ceramic composite materials with grains in the form of needles made of carbide, nitride, oxide or similar materials, where the diameter of the needle is significantly smaller than the height with which they still protrude from the second layer. Since the second layer already covers the structures at least partially, the part of the structures to be vaporised or melted is smaller than the height of the structures with which they protrude from the first layer. Due to the thin shape of the structures, the energy injected by the laser beam cannot flow quickly enough over the structure into the second layer, so that the residual needles are heated so much that they vaporise without heating the cladded second layer too much. A laser beam guided over the surface vaporises the remaining structures and smoothes the surface considerably. The laser beam smoothes the surface in a continuous process in which the structures are not detected separately, but rather, depending on their length, pass through the laser beam in a statistical process and are thus smoothed or vaporised. Preferably, the laser cladding head is used as the material removal unit, since the optical components and the light source are already present and the parameters of the laser beam and the beam guidance only need to be adapted to the material removing purpose.

In an alternative embodiment, when the first layer is completely covered by the second layer, the latter is removed over the entire surface by the material removal unit at least until the structures are reached. For this purpose, the material removal unit can be designed, for example, as a grinding, milling or other mechanical processing unit. Such material removal units can remove the second layer over a large area, depending on the design, so that the reworking step can be carried out effectively and with as little reworking time as possible.

In a further embodiment, the material removal unit is configured to stop the removing when at least the highest or some of the highest structures protruding from the surface of the first layer are reached by the material removal unit as a result of the removing process. Thus, the structures protruding from the first layer do not yet determine the surface roughness of the second layer and thus that of the coated component, but they nevertheless substantially influence the strength of the overall layer comprising the first and second layers, which substantially contributes to the durability of the overall layer package.

In a further embodiment, the material removal unit comprises a sensor which, during the removing process, detects a transition between the sole removal of the material with second hardness to an at least partial removal of the structures with first hardness. The sensor may use any suitable technology to distinguish, for example, between a softer material (second layer) and a harder material (said structures of the first layer), a change in surface structure, surface roughness and/or other differences in properties between the first and second layers. In a preferred embodiment, the sensor is configured to detect the changing mechanical, optical and/or acoustic properties of the material to be removed at the transition. For this purpose, the sensor may be a force sensor, a torque sensor, a rotation speed sensor, a surface roughness sensor, an optical, tactile, capacitive, inductive or acoustic sensor.

In a further embodiment, the device comprises a plurality of laser cladding heads for (quasi-) simultaneous cladding of material on a surface of the component, all of which are supplied in the device with the material to be cladded and with laser radiation for carrying out the laser cladding. The term “(quasi-) simultaneous cladding” refers to the process of laser cladding whereby separate cladding tracks are cladded on the surface per laser cladding head simultaneously (in advance or in succession) with other cladding tracks by means of other laser cladding heads. This (quasi-) simultaneous cladding takes place at the same time, but at different positions on the component, i.e. at different locations on the component. Thus, the material cladded to the surface per time unit increases proportionally with the number of laser cladding heads. The separate cladding tracks can be adjacent to each other or, if necessary, at least partially overlap. If necessary, the separate cladding tracks can also be cladded directly on top of each other. The (quasi-) simultaneous cladding of material by means of several laser cladding heads enables an even more effective laser cladding process with a higher cladding rate for a wide range of materials at a shorter process time for the component than would be possible with only one laser cladding head. To achieve a shorter process time, the feed rate does not need to be increased compared to known methods, which improves the quality of the cladded layer and helps to avoid layer defects such as crack formation by means of a process-appropriate feed rate. For example, when processing brake discs by means of laser cladding, previously usual processing times of 3-15 minutes can be reduced to less than 1 minute. In another embodiment, each laser cladding head applies the cladding track generated by it at least partially overlapping the adjacent cladding tracks generated by the other laser cladding heads, so that the material is cladded over the surface.

In a further embodiment, the laser cladding points generate cladding tracks with a material width along the feed direction on the surface, in which a first offset of adjacent laser cladding points is between 10% and 90%, preferably between 40% and 60%, particularly preferably 50%, of the material width of the cladding track. The term “adjacent laser cladding points” refers to two laser cladding points which produce cladding tracks of material cladded to the surface of the component, which are adjacent to each other and which can, if necessary, at least partially overlap in order to produce an areal cladding of the material. Adjacent laser cladding points can be generated by adjacent laser cladding heads. Here, adjacent laser cladding points and/or laser cladding heads do not necessarily designate laser cladding points or laser cladding heads that have the smallest geometric distance from one another, but are or generate those laser cladding points that generate adjacent cladding tracks. Due to the at least first offset of the adjacent laser cladding points to each other, the preheating of the component can be controlled in a targeted manner, which simplifies the processing of difficult-to-weld alloys or, depending on the alloy, makes it possible in the first place. The at least first offset of a suitable size also reduces the amount of reworking required.

In another embodiment, the adjacent laser cladding points on the surface of the component have a second offset from each other in the feed direction. Through this second offset of the laser cladding points, the preheating of the component can also be controlled in a targeted manner, in particular in interaction with the first offset, which further simplifies the processing of difficult-to-weld alloys or, depending on the alloy, makes it possible in the first place. The second offset with a suitable size, especially in interaction with the first offset, also further reduces the amount of reworking required. In this case, the laser cladding head with the second offset to the adjacent cladding track can be used to remelt the neighbouring cladding track in addition to cladding its own cladding track.

In a further embodiment, the device is configured to be cladded at least a third layer between the component and the first layer.

The invention further relates to a method for operating a device according to the invention for laser cladding, having a laser cladding unit with at least one laser cladding head arranged thereon for cladding material in the form of one or more adjacent cladding tracks onto a surface of a component for producing material layers resulting therefrom, one or more material sources for supplying the laser cladding head with the material to be cladded, and a laser beam source for supplying the laser cladding head with laser light for carrying out the laser cladding, and a material removal unit for processing the cladded material, comprising the following steps:
cladding at least a first layer of a material comprising structures protruding from the surface of the first layer and having a first hardness;
applying a second layer of a material having a second hardness lower than the first hardness, a layer thickness of the second layer being dimensioned such that the second layer at least partially covers the structures protruding from the first layer.

With the method according to the invention, a laser cladding process is effectively carried out, which enables a simple, reliable and less wear-intensive reworking effort.

In one embodiment of the method, wherein the structures each have a highest point and, in a valley between adjacent structures, the adjacent structures each have a lowest point associated therewith, a distance between the highest and lowest points of the respective structure representing the height thereof, the application of the second layer is carried out until the second layer protrudes from the first layer and covers the structures at least up to 20%, preferably at least 30%, more preferably at least 40%, particularly preferably at least 50%, of the average height of all the structures; alternatively, the second layer also completely covering the structures protruding from the first layer. In the latter case, the layer thickness of the second layer may be greater than the height of the highest structure protruding from the first layer.

In a further embodiment, the method comprises the further step of:
At least partially removing of the structures of the first layer protruding from the second layer by a material removal unit in case the structures are not completely covered by the second layer, or
partially removing of the second layer by means of the material removal unit in the case of complete covering of the structures of the first layer by the second layer.

In a further embodiment of the method, the removing of the structures is carried out by the material removal unit vaporising or melting the structures, preferably the laser cladding head is used as the material removal unit for this purpose, or the removing of the second layer is carried out by the material removal unit removing the second layer over the entire surface at least until the structures are reached.

In a further embodiment, the method comprises the further step of:
Stopping the removing of the second layer when at least the highest or some of the highest structures protruding from the surface of the first layer are reached by the material removal unit as a result of the removing process.

In a further embodiment, the method comprises the further step of detecting, by means of a sensor of the material removal unit, a transition in the removing process between the removing of the second hardness material alone to an at least partially removing of the first hardness structures. In a further embodiment, the sensor detects the changing mechanical, optical and/or acoustic properties of the material to be removed at the transition.

In a further embodiment, prior to cladding the first layer, the method comprises the further step of cladding a third layer or further layers onto the component, onto which the first layer is then cladded.

In a further embodiment of the method, the material removal unit moves over the surface of the component in a manner analogous to the laser cladding head.

In a further embodiment, the method comprises using a plurality of laser cladding heads in the device for cladding the material, all laser cladding heads in the device being supplied with the material to be cladded and with laser radiation for carrying out the laser cladding.

The invention further relates to a component having a surface onto which a first layer of a material comprising structures protruding from the surface of the first layer and having a first hardness is cladded by means of a device or process according to the invention, and wherein a second layer of a material having a second hardness less than the first hardness is cladded to the first layer, wherein the second layer at least partially covers the structures protruding from the first layer and a surface of the second layer or the structures, respectively, have been shaped after the cladding of the first and second layers such that the structures no longer protrude from the second layer. In this case, the material of the second layer may be a metal or a metal alloy. Here, the first layer may comprise a composite material having a matrix material with a third hardness less than the first hardness, preferably the first layer comprises the composite material where the structures are embedded in the matrix material. Here, the composite material may be a metal-ceramic composite material containing grains forming the structures, preferably the grains are carbide grains. Here, the material of the second layer may be the matrix material of the first layer. Here, a third layer may be cladded on the surface to which the first layer is cladded.

The embodiments listed above may be used individually or in any combination in deviation from the dependencies in the claims to each other for designing the devices or methods according to the invention.

### LIST OF FIGURES

These and other aspects of the invention are shown in detail in the figures as follows.

FIG. 1: an embodiment of the laser cladding device according to the invention;

FIG. 2: a side view of the component (a) with the first layer and the structures protruding therefrom and (b) after partial covering of these structures by the second layer;

FIG. 3: a further embodiment of the laser cladding device according to the invention with a material removal unit for protruding structures to be removed from the second layer;

FIG. 4: a further embodiment of the laser cladding device according to the invention with a material removal unit for removing the second layer which completely covers the protruding structures;

FIG. 5: a further embodiment of the device for laser cladding according to the invention with a material removal unit using several laser cladding heads for (quasi-) simultaneous cladding of the material on components with a planar surface;

FIG. 6: a further embodiment of the device according to the invention for laser cladding with material removal unit using several laser cladding heads for (quasi-) simultaneous cladding of the material on components with a cylindrical surface; and

FIG. 7: an embodiment of the method for operating the device according to the invention.

### DETAILED DESCRIPTION OF THE EMBODIMENTS

FIG. 1 shows an embodiment of the device 1 according to the invention for laser cladding, having a laser cladding unit 2 with at least one laser cladding head 3 arranged thereon, one or more material sources 5 for supplying the laser cladding head 3 with a material M to be cladded, and a laser beam source 6 for supplying the laser cladding head 3 with laser light L for carrying out the laser cladding, the device being configured to carry out the cladding of material layers 42, 43, 44 from adjacent cladding tracks MS onto a surface 41 of a component 4 in the form of at least a first layer 42 of a material M which comprises structures 42s protruding from the surface of the first layer 42 and having a first hardness H1 and a second layer 42 cladded thereon of a material M having a second hardness H2 less than the first hardness H1, the cladding process being controlled in such a way that the second layer 43 at least partially covers the structures 42s protruding from the first layer 42. Here, the material of the second layer 43 may be a metal or a metal alloy. In this case, the first layer 42 may comprise a composite material VM comprising a matrix material MM having a third hardness H3 lower than the first hardness H1. Preferably, the first layer 42 comprises the composite material VM and the structures 42s are at least partially embedded in the matrix material MM. The composite material VM may be a metal-ceramic composite material comprising grains forming the structures 42s, preferably the grains are carbide grains. The material of the second layer 43 may also be the matrix material MM of the first layer 42.

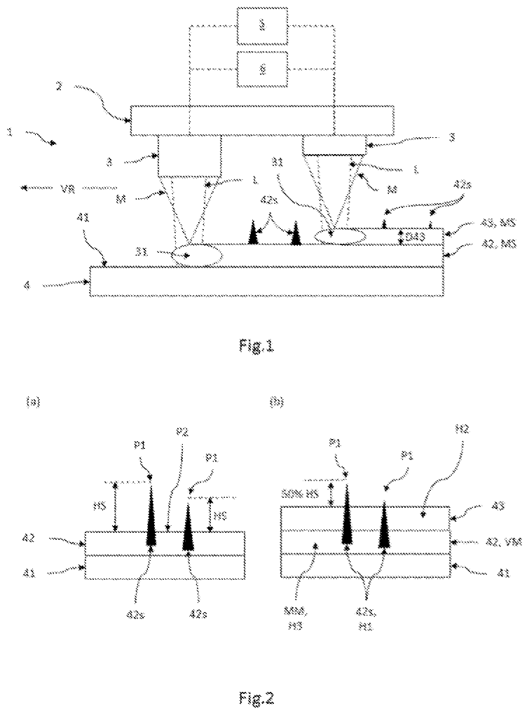

FIG. 2 shows a side view of the component 4 (a) with the first layer 42 and the structures 42s protruding therefrom and (b) after partial covering of these structures 42s by the second layer 43. The structures 42s each have a highest point P1 and, in the valley between adjacent structures 42s, the structures 42s adjoining the valley there each have a lowest point P2 assigned to them, a distance between the highest and lowest points P1, P2 of the respective structure 42s representing its height Hs and the second layer 43 protruding from the first layer 42 covering the structures 42s at least up to 20%, preferably at least 30%, more preferably at least 40%, particularly preferably at least 50%, of the average height Hs of all structures 42s. In this case, the structures 42s generally all have different heights Hs, the covering referring to an average height. Thus, Individual structures 42s can exist which, with an average cover of, for example, 50%, still protrude more than 50% from the second layer 43. On the other hand, other structures 42s are covered by more than 50% by the second layer 43, resulting in an average degree of coverage of, for example, 50%. However, the second layer 43 may also completely cover the structures 42s protruding from the first layer 42. In the case of carbide grains in a metal-ceramic composite material, these grains can reach heights Hs of approximately 100 μm.

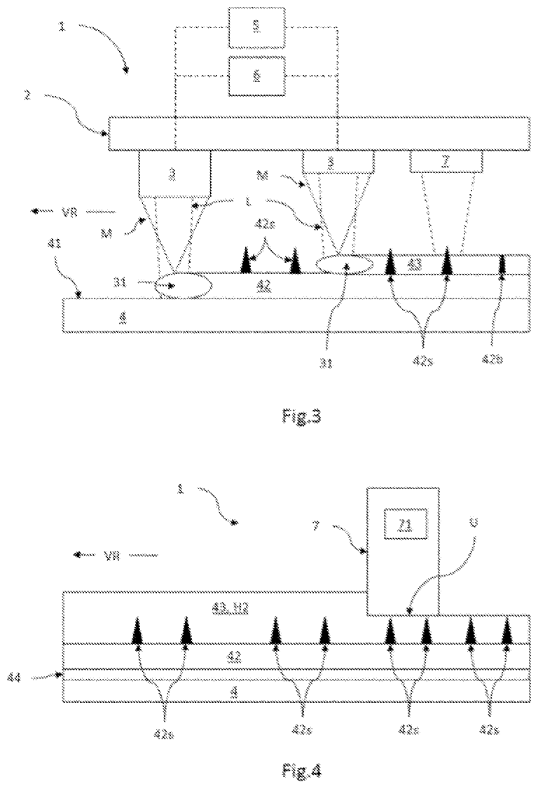

FIG. 3 shows a further embodiment of the device 1 for laser cladding according to the invention with a material removal unit 7 for removing the structures 42s also protruding from the second layer 43, which is provided for at least partially removing the structures 42s of the first layer 42 protruding from the second layer 43 when the first layer 42 is not completely covered. In this case, the material removal unit 7 is, for example, a laser melting or laser ablation unit, the material removal unit 7 being arranged on the laser cladding head 2 behind the laser cladding head 3, as seen in the feed direction VR of the laser cladding head 3. As a result, the structures 42s of the first layer 42 protruding from the second layer 43 are vaporised or melted by the material removal unit 7 and thus removed to such an extent that they no longer protrude from the second layer 43. In the example shown here, only stubs of the needles 42s remain in the second layer 43, so that the surface of the second layer 43 has a low surface roughness after reworking by the material removal unit 7. In a preferred embodiment, the laser cladding head 3 is used as the material removal unit 7.

FIG. 4 shows a further embodiment of the device 1 for laser cladding according to the invention with a material removal unit 7 for removing the second layer 43 which completely covers the protruding structures 42s, whereby here the second layer 43 is only partially removed until it reaches the structures 42s, but it is removed over the entire surface. The material removal unit 7 can be a grinding unit or a milling unit. The material removal unit is configured to stop the removing process when at least the highest or some of the highest structures 42s protruding from the surface of the first layer 42 are reached by the material removal unit 7 as a result of the removing process. For this purpose, the material removal unit 7 comprises a sensor 71 which, during the removing process, detects a transition U between the sole removing of the material with second hardness H2 to an at least partial removing of the structures 42s with first hardness H1, for which purpose it detects the mechanical, optical and/or acoustic properties of the material to be removed which change at the transition U. The sensor 71 may be, for example, a force sensor, a torque sensor, a rotation speed sensor, a surface roughness sensor, an optical sensor or an acoustic sensor. Furthermore, it is shown here that at least a third layer 44 is cladded between the component 4 and the first layer 42, where the device 1 is also configured to be cladded. This third layer 44 may also be additionally present in all other embodiment examples.

FIG. 5 shows a further embodiment of the device 1 according to the invention for laser cladding with material removal unit 7 using several laser cladding heads 3 for (quasi-) simultaneous cladding of the material M on components 4 with a planar surface 41. For this purpose, the device 1 supplies all laser cladding heads 3 with the material M to be cladded and with laser radiation L for carrying out the laser cladding. The laser cladding points 31 thereby generate cladding tracks MS with a material width along the feed direction VR on the surface 41, in which a first offset R1 of adjacent laser cladding points 31 is between 10% and 90%, preferably between 40% and 60%, particularly preferably 50%, of the material width of the cladding track MS. Furthermore, the adjacent laser cladding points 31 on the surface 41 of the component 4 have a second offset R2 from one another in the feed direction VR. Here, the component 4 in the form of a brake disc comprises a circular surface 41 with an axis of rotation D perpendicular to the surface 41 onto which the material is cladded. In this case, the brake disc 4 could be mounted on a rotary table by means of the screw holes (four points around the centre), by means of which the brake disc 4 is rotated about the axis of rotation D. To clad 110, 120, 170 the material M, the circular surface 41 is rotated about the axis of rotation D under the laser cladding heads 3 so that their laser cladding point 31 on the circular surface 41 would sweep the surface 41 in a circular manner when the laser cladding head 3 is stationary, and the laser cladding heads 3 are simultaneously moved in the direction of the axis of rotation D so that the material M is cladded in a spiral cladding track MS over the area of the circular surface 41. In this case, the material removal unit 7 extends over the entire radius of the surface 41 and, if necessary, moves subsequently over the surface 41 in analogy to the laser cladding points 31. Alternatively, at least one of the several laser cladding heads 3 can also be configured to be operated as a material removal unit 7.

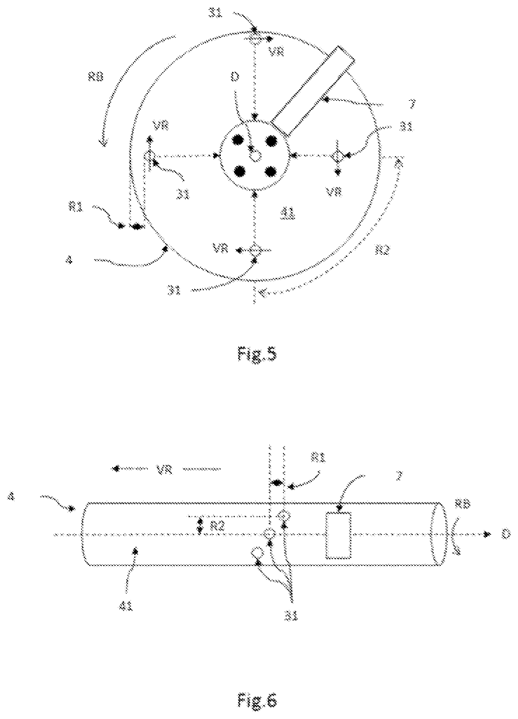

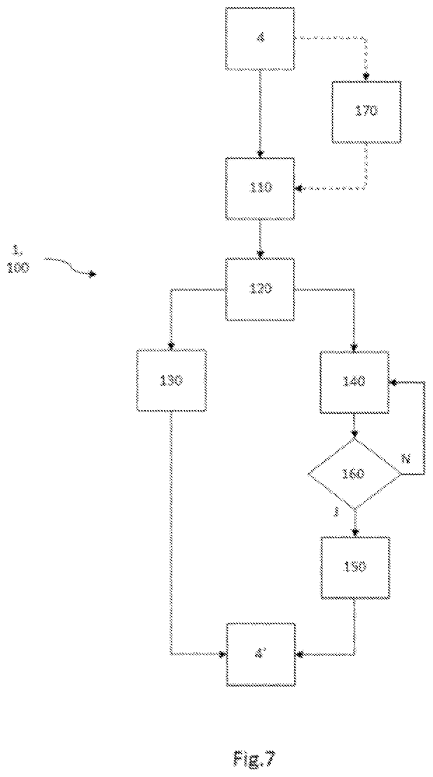

FIG. 6 shows a further embodiment of the device 1 according to the invention for laser cladding with material removal unit 7 using several laser cladding heads 3 for (quasi-) simultaneous cladding of the material M on components 4 with a cylindrical surface 41 in the example as a shaft for rotationally symmetrical components 4 with the dynamic behaviour of the laser cladding points 31 during laser cladding of a device 1 according to the invention in this embodiment with three laser cladding heads 3 and a material removal unit 7. The three laser cladding heads 3 (indicated here as laser cladding points 31) (quasi-) simultaneously clad material M onto the surface 41 of the component 4, wherein the laser cladding heads 3 each generate a laser cladding point 31 on the surface 41 of the component 4 and adjacent laser cladding points have a first offset R1 from one another perpendicular to a feed direction VR of the laser cladding points 31 on the surface 41 of the component 4. In this case, each laser cladding head 3 clads the cladding track MS generated by it at least partially overlapping the adjacent cladding tracks MS generated by the other laser cladding heads 3, so that the material M is cladded over an area on the surface 41. In addition, the adjacent laser cladding points 31 on the surface 41 of the component 4 have a second offset R2 from one another in the feed direction VR, on the one hand in order to be able to control the heat transfer to adjacent cladding tracks MS and, on the other hand, in order not to have to arrange the laser cladding heads 3 too close to one another for geometric reasons. Here, the shaft 4 comprises a rotationally symmetrical surface 41 with an axis of rotation D parallel to the surface 41 onto which the material is cladded. For cladding 110, 120, 170, the rotationally symmetrical surface 41, preferably the cylindrical surface of the shaft 4, is rotated about the axis of rotation RB under the three laser cladding heads 3 so that their laser cladding point 31 on the rotationally symmetrical surface 41 would run over the surface 41 in a circle when the laser cladding head 3 is at rest; and the laser cladding heads 3 are moved in the feed direction VR parallel to the axis of rotation RB so that the material M is cladded in a spiral cladding track MS over the surface of the rotationally symmetrical surface 41. In this case, the material removal unit 7 extends over the entire radius of the surface 41 and, if necessary, moves subsequently over the surface 41 in analogy to the laser cladding tracks 31. The first offset R1 of adjacent laser cladding tracks 31 can be between 10% and 90%, preferably between 40% and 60%, particularly preferably 50%, of the material width MB of the cladding track MS. The second offset R2 is set in such a way that temperature profiles induced by the laser cladding points 31 on the surface 41 overlap to such an extent that the material M in an overlap region of adjacent cladding tracks MS still has a residual heat that is usable/beneficial for the process. Alternatively, at least one of the several laser cladding heads 3 can be configured to be operated as a material removal unit 7.

FIG. 7 shows an embodiment of the method according to the invention for operating the device according to the invention for laser cladding in accordance with one of the preceding claims, having a laser cladding unit 2 with at least one laser cladding head 3 arranged thereon for cladding material M in the form of one or more adjacent cladding tracks MS onto a surface 41 of a component 4 in order to produce resulting material layers 42, 43, 44, one or more material sources 5 for supplying the laser cladding head 3 with the material M to be cladded and a laser beam source 6 for supplying the laser cladding head 3 with laser light L for carrying out the laser cladding and a material removal unit 7 for processing the cladded material, comprising the following steps of cladding 110 at least a first layer 42 of a material which comprises structures 42s protruding from the surface 41 of the first layer 42 and having a first hardness H1; cladding 120 a second layer 43 of a material having a second hardness H2 less than the first hardness H1, a layer thickness D43 of the second layer 43 being dimensioned such that the second layer 43 at least partially covers the structures 42s protruding from the first layer 42; the at least partially removing 130 of the structures 42s of the first layer 42 protruding from the second layer 43 by a material removal unit 7 in the case of incomplete covering of the structures 42s by the second layer 43, or the partially removing 140 of the second layer 43 by means of the material removal unit 7 in the case of complete covering of the structures 42s of the first layer 42 by the second layer 43. In this case, the removing 130 of the structures 42s can be carried out by the material removal unit 7 vaporising or melting the structures 42s, preferably the laser cladding head 3 is used as the material removal unit 7 for this purpose. Alternatively, when the structures 42s are completely covered, the removing 140 of the second layer 43 is carried out by the material removal unit 7 removing the full surface of the second layer 43 at least until the structures 42s are reached, wherein a stopping 150 of the removing 140 of the second layer 43 takes place when at least the highest or some of the highest structures 42s protruding from the surface of the first layer 42 are reached by the material removal unit 7 as a result of the removing process 130. For this purpose, the method comprises the further step of detecting 160, by means of a sensor 71 of the material removal unit 7, a transition U in the removing process 140 between the sole removing of the material with second hardness H2 to an at least partially removing of the structures 42s with first hardness H1. If the transition U has not yet been reached (“N”), the removing process is continued. If, on the other hand, the transition has been reached (“J”), the removing process is stopped. For this purpose, the sensor 71 can detect the changing mechanical, optical and/or acoustic properties of the material to be removed at the transition U. In some embodiments, prior to cladding 110 the first layer 42, the method comprises the further step of cladding 170 a third layer 44 or further layers onto the component 4, onto which the first layer 42 is then cladded. It is also advantageous for an effective manufacturing process if the material removal unit 7 moves over the surface 41 of the component 4 in the same way as the laser cladding head 3. The laser cladding process can be shortened in terms of time by using several laser cladding heads 3 in the device 1 for a (quasi-) simultaneous material cladding, whereby all laser cladding heads 3 in the device 1 are supplied with the material M to be cladded and with laser radiation L for carrying out the laser cladding. The product produced by the method according to the invention is a component 4′ having a surface 41 on which a first layer 42 of a material M comprising structures 42s protruding from the surface of the first layer 42 and having a first hardness H1 is cladded, and wherein a second layer 43 of a material M having a second hardness H2 smaller than the first hardness H1 is cladded on the first layer 42, wherein the second layer 43 at least partially covers the structures 42s protruding from the first layer 42, and wherein a surface of the second layer 43 or the structures 42s, respectively, have been shaped after application of the first and second layers 42, 43 such that the structures 42s no longer protrude from the second layer 43. For further details of the first, second and possibly third layer, see the description of FIG. 1.

It is understood that the embodiment example explained above is only a first embodiment of the present invention. In this respect, the embodiment of the invention is not limited to this embodiment example.

### LIST OF REFERENCE NUMERALS

1 laser cladding device according to the invention
2 laser cladding unit
3 laser cladding head
31 laser cladding point
4 component at the start of laser cladding
4′ component with cladded layers
41 surface of the component
42 first layer
42s structures protruding from the first layer
42b post-treated structures protruding from the first layer
43 second layer
44 third layer material source
6 laser beam source
7 material removal unit
71 sensor of the material removal unit
100 method according to the invention for operating a device for laser cladding
110 cladding at least a first layer onto the surface of the component
120 cladding of a second layer onto the first layer
130 at least partially removing of the structures protruding from the second layer by means of the material removal unit
140 partially removing of the second layer by means of the material removal unit
150 stopping the removing process
160 recognising a transition in the removing process between the sole removing of the material with second hardness to an at least partially removing of the structures with first hardness
170 cladding of a third layer between component and first layer
D axis of rotation of the component during laser cladding
D43 thickness of the second layer
H1 first hardness of the structures protruding from the first layer
H2 second hardness of the second layer
H3 third hardness of the matrix material
Hs height of the structure
M material to be cladded/cladded material
MM matrix material of the composite material of the first layer
MS cladding track of the cladded material on the surface of the component or layer of cladded material
L laser light
P1 highest point of a structure
P2 lowest point of a structure
R1 first offset of adjacent laser cladding points perpendicular to the feed direction
R2 second offset of adjacent laser cladding points to each other in feed direction
RB rotation of the component during laser cladding
U transition between the sole removing of the material with second hardness to an at least partially removing of the structures with first hardness
VM composite material of the first layer of matrix material and structures in the matrix material
VR feed direction of the laser cladding head

1-37. (canceled)

38. A device (1) for laser cladding comprising a laser cladding unit (2) with at least one laser cladding head (3) arranged thereon, one or more material sources (5) for supplying the laser cladding head (3) with a material (M) to be cladded and a laser beam source (6) for supplying the laser cladding head (3) with laser light (L) for carrying out the laser cladding, wherein the device is configured to carry out the cladding of material layers (42, 43, 44) from adjacent cladding tracks (MS) onto a surface (41) of a component (4) in the form of at least a first layer (42) of a material (M) comprising structures (42s) protruding from the surface of the first layer (42) and having a first hardness (H1) and a second layer (43) of a material (M) cladded thereon and having a second hardness (H2) lower than the first hardness (H1), wherein the cladding process is controlled so that the second layer (43) at least partially covers the structures (42s) protruding from the first layer (42).

39. The device (1) according to claim 38,
wherein
the material of the second layer (43) is a metal or a metal alloy.

40. The device (1) according to claim 38,
wherein
the first layer (42) comprises a composite material (VM) comprising a matrix material (MM) having a third hardness (H3) lower than the first hardness (H1), preferably the first layer (42) consists of the composite material (VM) and the structures (42s) are at least partially embedded in the matrix material (MM).

41. The device (1) according to claim 40,
wherein
the composite material (VM) is a metal-ceramic composite material comprising grains forming the structures (42s), preferably the grains are carbide, nitride or oxide grains.

42. The device (1) according to claim 40,
wherein
the material of the second layer (43) is the matrix material (MM) of the first layer (42).

43. The device (1) according to claim 38,
wherein
the structures (42s) each have a highest point (P1) and, in a valley between adjacent structures (42s), the adjacent structures (42s) each have a lowest point (P2) associated therewith, wherein a distance between the highest and lowest points (P1, P2) of the respective structure (42s) represents the height (Hs) thereof and the second layer (43) covers the structures (42s) protruding from the first layer (42) at least up to 20%, preferably at least 30%, more preferably at least 40%, particularly preferably at least 50%, of the average height (Hs) of all structures (42s).

44. The device (1) according to claim 38,
wherein
the second layer (43) completely covers the structures (42s) protruding from the first layer (42).

45. The device (1) according to claim 38,
wherein
the device (1) further comprises a material removal unit (7) which is provided for at least partially removing the structures (42s) of the first layer (42) protruding from the second layer (43) when the first layer (42) is not completely covered,
or
when the structures (42s) of the first layer (42) are completely covered by the second layer (43), then to partially remove the second layer (43).

46. The device (1) according to claim 45,
wherein
the material removal unit (7) is a grinding unit, a milling unit or a laser melting or laser ablation unit.

47. The device (1) according to claim 45,
wherein
the material removal unit (7) is arranged on the laser cladding head (2) behind the laser cladding head (3) as seen in the feed direction (VR) of the laser cladding head (3).

48. The device (1) according to claim 45,
wherein
the structures (42s) of the first layer (42) protruding from the second layer (43) are at least partially removed by these (42s) being vaporized or melted by the material removal unit (7).

49. The device (1) according to claim 48,
wherein
as the material removal unit (7) the laser cladding head (3) is used.

50. The device (1) according to claim 45,
wherein
when the first layer (42) is completely covered by the second layer (43), the latter is removed over the entire surface by the material removal unit (7) at least until reaching the structures (42s).

51. The device (1) according to claim 50,
wherein
the material removal unit (7) is configured to stop the removing when at least the highest or some of the highest structures (42s) protruding from the surface of the first layer (42) are reached by the material removal unit (7) as a result of the removing process.

52. The device (1) according to claim 50,
wherein
the material removal unit (7) comprises a sensor (71) which, during the removing process, detects a transition (U) between the sole removal of the material with second hardness (H2) to an at least partial removal of the structures (42s) with first hardness (H1).

53. The device (1) according to claim 52,
wherein
the sensor (71) is configured to detect the changing mechanical, optical and/or acoustic properties of the material to be removed at the transition (U).

54. The device (1) according to claim 52,
wherein
the sensor (71) is a force sensor, a torque sensor, a rotation speed sensor, a surface roughness sensor, an optical, tactile, capacitive, inductive or acoustic sensor.

55. The device (1) according to claim 38,
wherein
the device (1) comprises a plurality of laser cladding heads (3) for (quasi-) simultaneous cladding of material (M) on the surface (41) of a component (4), all of which are supplied in the device (1) with the material (M) to be cladded and with laser radiation (L) for carrying out the laser cladding.

56. The device (1) according to claim 55,
wherein
the laser cladding points (31) produce cladding tracks (MS) with a material width along the feed direction (VR) on the surface (41), in which a first offset (R1) of adjacent laser cladding points (31) is between 10% and 90%, preferably between 40% and 60%, particularly preferably 50%, of the material width of the cladding track (MS).

57. The device (1) according to claim 55,
wherein
the adjacent laser cladding points (31) on the surface (41) of the component (4) have a second offset (R2) relative to one another in the feed direction (VR).

58. The device (1) according to claim 38,
wherein
the device (1) is configured to be cladded at least a third layer (44) between the component (4) and the first layer (42).

59. A method (100) for operating a laser cladding device (1) according to claim 38, having a laser cladding unit (2) having at least one laser cladding head (3) arranged thereon for cladding material (M) in the form of one or more adjacent cladding tracks (MS) onto a surface (41) of a component (4) to produce resulting layers of material (42, 43, 44), one or more material sources (5) for supplying the laser cladding head (3) with the material (M) to be cladded and a laser beam source (6) for supplying the laser cladding head (3) with laser light (L) for carrying out the laser cladding, and a material removal unit (7) for processing the cladded material, comprising the following steps:
cladding (110) at least a first layer (42) of a material comprising structures (42s) protruding from the surface (41) of the first layer (42) and having a first hardness (H1);
cladding (120) a second layer (43) of a material having a second hardness (H2) less than the first hardness (H1), wherein a layer thickness (D43) of the second layer (43) is such that the second layer (43) at least partially covers the structures (42s) protruding from the first layer (42).

60. The method (100) according to claim 59, wherein the structures (42s) each have a highest point (P1) and, in a valley between adjacent structures (42s), the adjacent structures (42s) each have a lowest point (P2) associated therewith, wherein a distance between the highest and lowest points (P1, P2) of the respective structure (42s) representing its height (Hs), the cladding (120) of the second layer (43) is carried out until the second layer (43) covers the structures (42s) protruding from the first layer (42) at least up to 20%, preferably at least 40%, more preferably at least 60%, particularly preferably at least 80%, of the average height (Hs) of all structures (42s), alternatively the second layer (43) also completely covering the structures (42s) protruding from the first layer (42).

61. The method (100) according to claim 60, comprising the further step:
At least partially removing (130) the structures (42s) of the first layer (42) protruding from the second layer (43) by a material removal unit (7) in case the structures (42s) are not completely covered by the second layer (43),
or
partially removing (140) the second layer (43) by means of the material removal unit (7) in the case of complete covering of the structures (42s) of the first layer (42) by the second layer (43).

62. The method (100) according to claim 61, wherein the removing (130) of the structures (42s) is carried out by the material removal unit (7) vaporising or melting the structures (42s), preferably the laser cladding head (3) is used as the material removal unit (7) for this purpose,
or the removing (140) of the second layer (43) is carried out by the material removal unit (7) removing the second layer (43) over the entire surface at least until the structures (42s) are reached.

63. The method (100) according to claim 62, comprising the further step of:
Stopping (150) the removing (140) of the second layer (43) when at least the highest or some of the highest structures (42s) protruding from the surface of the first layer (42) are reached by the material removal unit (7) as a result of the removing process (130).

64. The method (100) according to claim 60, comprising the further step of detecting (160), by means of a sensor (71) of the material removal unit (7), a transition (U) in the removing process (140) between the removing of the material with second hardness (H2) alone to an at least partially removing of the structures (42s) with first hardness (H1).

65. The method (100) according to claim 64, wherein for this purpose the sensor (71) detects at the transition (U) the changing mechanical, optical and/or acoustic properties of the material to be removed.

66. The method (100) according to claim 59, wherein the method comprises, before cladding (110) the first layer (42), the further step of cladding (170) a third layer (44) or further layers onto the component (4), onto which the first layer (42) is then cladded.

67. The method (100) according to claim 59, wherein the material removal unit (7) moves over the surface (41) of the component (4) in a manner analogous to the laser cladding head (3).

68. The method (100) according to claim 59, comprising using a plurality of laser cladding heads (3) in the device (1) for cladding (110, 120, 170) the material (M), wherein all laser cladding heads (3) in the device (1) are supplied with the material (M) to be cladded and with laser radiation (L) for carrying out the laser cladding.

69. A component (4′) having a surface (41) on which a first layer (42) of a material (M) comprising structures (42s) protruding from the surface of the first layer (42) and having a first hardness (H1) is cladded by means of a device (1) according to claim 38, and wherein a second layer (43) of a material (M) having a second hardness (H2) lower than the first hardness (H1) is cladded on the first layer (42), wherein the second layer (43) at least partially covers the structures (42s) protruding from the first layer (42), and a surface of the second layer (43) or the structures (42s), respectively, has been shaped after the application of the first and second layers (42, 43) in such a way that the structures (42s) no longer protrude from the second layer (43).

70. The component (4′) according to claim 69,
wherein
the material of the second layer (43) is a metal or a metal alloy.

71. The component (4′) according to claim 68,
wherein
the first layer (42) comprises a composite material (VM) comprising a matrix material (MM) having a third hardness (H3) less than the first hardness (H1), preferably the first layer (42) consists of composite material (VM) where the structures (42s) are embedded in the matrix material (MM).

72. The component (4′) according to claim 71,
wherein
the composite material (VM) is a metal-ceramic composite material comprising grains forming the structures (42s), preferably the grains are carbide, nitride or oxide grains.

73. The component (4′) according to claim 71,
wherein
the material of the second layer (43) is the matrix material (MM) of the first layer (42).

74. The component (4′) according to claim 38,
wherein
a third layer (44) is cladded on the surface (41) on which the first layer (42) is cladded.
